(19) United States
(12) Patent Application Publication
(10) Pub. No.: US 2024/0072287 A1
(43) Pub. Date: Feb. 29, 2024

(54) CATHODE SCREEN SUPPORT FOR MOLTEN CARBONATE FUEL CELL

(71) Applicant: EXXONMOBIL TECHNOLOGY AND ENGINEERING COMPANY, ANNANDALE, NJ (US)

(72) Inventors: Abdelkader HILMI, Bethel, CT (US); Chao-Yi YUH, New Milford, CT (US); Timothy C. GEARY, Stamford, CT (US); Aaron SATTLER, Annandale, NJ (US); William C. HORN, Long Valley, NJ (US); William A. LAMBERTI, Stewartsville, NJ (US); Gabor KISS, Hampton, NJ (US)

(21) Appl. No.: 18/229,805

(22) Filed: Aug. 3, 2023

Related U.S. Application Data
(60) Provisional application No. 63/373,496, filed on Aug. 25, 2022.

(51) Int. Cl. H01M 8/14; H01M 8/0247; H01M 8/244

(52) U.S. Cl. CPC H01M 8/142; H01M 8/0247; H01M 8/244; H01M 2008/147

(57) ABSTRACT

Molten carbonate fuel cell structures are provided that include a structural mesh support layer at the interface between the surface of the cathode and the cathode current collector. The structural mesh layer can have a mesh open area of 25% to 45%. In addition to providing structural support, the structural mesh layer can reduce or minimize ohmic resistance at the interface between the cathode and the cathode current collector.

### CROSS REFERENCE TO RELATED APPLICATIONS

This application claims the benefit of U.S. Provisional Application No. 63/373,496, filed Aug. 25, 2022, the entirety if which is hereby incorporated by reference.

### FIELD OF THE INVENTION

Cathode screen supports for improving the interface between the cathode and the cathode current collector in a molten carbonate fuel cell are provided, along with methods of operating such a fuel cell.

### BACKGROUND OF THE INVENTION

Molten carbonate fuel cells utilize hydrogen and/or other fuels to generate electricity. The hydrogen may be provided by reforming methane or other reformable fuels in a steam reformer, such as steam reformer located upstream of the fuel cell or integrated within the fuel cell. Fuel can also be reformed in the anode cell in a molten carbonate fuel cell, which can be operated to create conditions that are suitable for reforming fuels in the anode. Still another option can be to perform some reforming both externally and internally to the fuel cell. Reformable fuels can encompass hydrocarbonaceous materials that can be reacted with steam and/or oxygen at elevated temperature and/or pressure to produce a gaseous product that comprises hydrogen.

The basic structure of a molten carbonate fuel cell includes a cathode, an anode, and a matrix between the cathode and anode that includes one or more molten carbonate salts that serve as the electrolyte. During conventional operation of a molten carbonate fuel cell, the molten carbonate salts partially diffuse into the pores of the cathode. This diffusion of the molten carbonate salts into the pores of the cathode provides an interface region where CO₂ can be converted into CO₃²⁻ for transport across the electrolyte to the anode.

In addition to these basic structures, volumes adjacent to the anode and cathode are typically included in the fuel cell. This allows an anode gas flow and a cathode gas flow to be delivered to the anode and cathode, respectively. In order to provide the volume for the cathode gas flow while still providing electrical contact between the cathode and the separator plate defining the outer boundary of the fuel cell, a cathode current collector structure can be used. An anode collector can be used to similarly provide the volume for the anode gas flow.

U.S. Pat. Nos. 6,492,045 and 8,802,332 describe examples of current collectors for molten carbonate fuel cells. The current collectors correspond to corrugated structures.

U.S. Patent Application Publication 2020/0176783 describes cathode current collector structures that provide increased open area for a cathode surface adjacent to the cathode current collector. A mesh layer with a large open area that does not provide structural support was also described.

U.S. Patent Application Publication 2021/0159523 describes examples of how to manage the flows to a fuel cell when operated in co-current or counter-current mode.

### SUMMARY OF THE INVENTION

In an aspect, a molten carbonate fuel cell is provided. The fuel cell includes an anode. The fuel cell further includes a first separator plate. The fuel cell further includes an anode collector in contact with the anode and the first separator plate to define an anode gas collection zone between the anode and the first separator plate. The fuel cell further includes a cathode having a cathode surface. The fuel cell further includes a second separator plate. The fuel cell further includes a cathode current collector in contact with the second separator plate and adjacent to the cathode surface to define a cathode gas collection zone between the cathode and the second separator plate. The cell further includes a structural mesh layer disposed between the cathode surface and the cathode current collector, the structural mesh layer comprising 50 openings/cm² or more and having a mesh contact area of 55% to 75%. Additionally, the fuel cell includes an electrolyte matrix comprising an electrolyte between the anode and the cathode. Optionally, the contact area of the cathode current collector can be less than 55%.

Optionally, such a fuel cell can be used in a method for using a fuel cell. In such a method, the method can include introducing an anode input stream comprising H₂, a reformable fuel, or a combination thereof into the anode gas collection zone. The method can further include introducing a cathode input stream comprising O₂ and CO₂ into the cathode gas collection zone. Additionally, the method can include operating the molten carbonate fuel cell at an average current density of 60 mA/cm² or more to generate electricity, an anode exhaust, and a cathode exhaust.

### BRIEF DESCRIPTION OF THE FIGURES

FIG. 1 shows an example of a cathode current collector configuration with a mesh layer at the interface between the cathode current collector and the cathode surface.

FIG. 2 shows an example of a molten carbonate fuel cell.

FIG. 3 shows an example of a cathode current collector structure.

FIG. 4 shows an example of a repeating pattern unit that can be used to represent the cathode current collector structure shown in FIG. 3.

FIG. 5 shows another example of the repeating pattern unit of FIG. 4.

FIG. 6 shows a flow pattern example for a molten carbonate fuel cell with an anode flow direction that is aligned roughly perpendicular to a cathode flow direction.

FIG. 7 shows changes in ohmic resistance over time during operation of molten carbonate fuel cells that include or do not include a structural mesh layer.

FIG. 8 shows changes in operating voltage and ohmic resistance over time for molten carbonate fuel cells that include or do not include a structural mesh layer.

FIG. 9 shows changes in ohmic resistance over time for the fuel cells shown in FIG. 8.

FIG. 10 shows ohmic resistance versus CO₂ utilization for fuel cells including various types of mesh layers disposed between the cathode current collector and the cathode surface.

FIG. 11 shows operating voltage versus CO₂ utilization for fuel cells including various types of mesh layers disposed between the cathode current collector and the cathode surface.

FIG. 12 shows ohmic resistance versus CO₂ utilization for fuel cells including various types of mesh layers disposed between the cathode current collector and the cathode surface.

FIG. 13 shows operating voltage versus CO₂ utilization for fuel cells including various types of mesh layers disposed between the cathode current collector and the cathode surface.

FIG. 14 shows CO₂ capture selectivity for fuel cells operated at various CO₂ utilization levels.

### DETAILED DESCRIPTION OF THE EMBODIMENTS

### Overview

In various aspects, molten carbonate fuel cell structures are provided that include a structural mesh support layer at the interface between the surface of the cathode and the cathode current collector. The structural mesh layer can have a contact area of 55% to 75%, which corresponds to a mesh open area of 25% to 45%. In addition to providing structural support, the structural mesh layer can reduce or minimize ohmic resistance at the interface between the cathode and the cathode current collector while also maintaining favorable open area for transport of CO₂ from the cathode gas stream to the electrolyte.

Molten carbonate fuel cells provide an unusual and advantageous opportunity for performing carbon capture from power generation and industrial flue gases: Because CO₂ is used to form the carbonate ions for transport of electrical charge from the cathode to the anode, molten carbonate fuel cells can provide capture and transport of CO₂ from lower concentration cathode gas streams to higher concentration anode gas streams while also generating electrical power. Carbon capture processes utilizing molten carbonate fuel cells thus can be net energy exporters as opposed to the conventional carbon capture processes relying on CO₂ absorption or adsorption that require energy import.

CO₂ removed from the cathode stream of molten carbonate fuel cells can be recovered from the CO₂-enriched anode effluent for carbon capture or utilization. However, there are difficulties in using a molten carbonate fuel cell for capturing 80 vol % or more of CO₂ from a cathode feed stream because of the resulting depletion of CO₂ in the cathode gas. At such high levels of CO₂ utilization, it can be more difficult to maintain efficient operation of a fuel cell. CO₂ depletion may also reduce the life of the fuel cell. For example, at high levels of CO₂ utilization and/or low levels of CO₂ in the cathode inlet gas, a portion of the charge transferred across the electrolyte can potentially be transported in the form of alternative ions, such as hydroxyl ions. This “parasitic” charge transport consumes fuel fed to the anode without contributing to CO₂ removal. Such high CO₂ utilization can also lead to degradation of fuel cell performance due to a variety of factors.

One option for mitigating the difficulties with operating a molten carbonate fuel cell at high CO₂ utilization and/or low CO₂ concentration in the cathode is to use a cathode current collector structure that results in increased open area of the cathode surface (as defined by the cathode current collector). Such cathode current collector structures that provide increased open area of the cathode surface are described for example, in U.S. Patent Application Publication 2020/0176783. As described in U.S. Patent Application Publication 2020/0176783, using a cathode current collector structure with a contact area of 55% or less (i.e., that provides an open area of the cathode surface of 45% or more when in contact with the cathode surface) can provide a variety of advantages when operating a molten carbonate fuel cell at high CO₂ utilization. It is believed that these advantages are due in part to lower resistance for transporting CO₂ from the cathode gas stream into the cathode pores where CO₂ can contact the electrolyte present in the cathode. A cathode current collector structure that provides an open area of the cathode surface of 45% or more/a contact area of 55% or less is in contrast to conventional cathode current collector structure, which typically provide an open area of the cathode surface of roughly 33% or less/a contact area of 67% or more.

Although using a cathode current collector structure that provides increased open area of the cathode surface can be beneficial when operating at high CO₂ utilization and/or at low concentration of CO₂ in the cathode inlet gas, it has now been discovered that such a cathode current collector structure can cause increased ohmic resistance within the fuel cell. This can result in decreased cell operating voltage over time. Without being bound by any particular theory, the increased open area of the cathode current collector results in a corresponding decrease in the contact area between the cathode current collector and the cathode, which in itself will increase ohmic resistance due to the reduced total contact area between the cathode current collector and the cathode. Furthermore, it is believed that this decrease in contact area also results in increased deformation of both the cathode and the electrolyte matrix, as well as potentially an increase in the formation of scale at contact points between the cathode and the cathode current collector.

It has now been discovered that these difficulties with using a cathode current collector that provides increased open area of the cathode surface can be reduced, minimized, or mitigated by using a properly designed structural mesh layer between the cathode surface and the cathode current collector. In these novel molten carbonate fuel cells, instead of having the cathode current collector directly contact the cathode surface, the structural mesh layer can provide an improved electrical contact between the cathode and the cathode current collector. Furthermore, the structural mesh advantageously can improve the mechanical stability of, and gas transport within, the cells. It has been discovered that a structural mesh layer with a mesh open area that is lower than the open area of the cathode surface (as defined by the cathode current collector), can improve cell operation by reducing or minimizing loss of cell voltage over time. In some aspects, a structural mesh layer with a contact area of 55% to 75% (i.e., a mesh open area of 25% to 45%) can provide improved cell operating voltage while maintaining high selectivity for transport of carbonate ions across the electrolyte. Such a structural mesh layer with a mesh open area of 25% to 45% can also have a high density of openings per unit area. Thus, even though the mesh contact area is higher than the contact area of the cathode current collector, it is believed that the large number of openings per unit area allows the benefits of increased gas transfer from the cathode current collector volume to the cathode to be maintained. By combining a relatively low mesh open area (high contact area) with a relatively high density of openings in the mesh, the mesh can also provide sufficient structural stability to improve performance of the fuel cell.

In various aspects, the presence of the structural mesh layer allows the contact force of the cathode current collector to be distributed over a larger area while keeping a small size for the features that are in contact the cathode surface. This is beneficial in relation to the goal enhancing CO₂ transport from the cathode gas chamber into the cathode pores where the electrochemical process takes place. The small features of the structural mesh layer allow for a large amount of contact area while reducing or minimizing the average diffusion path required for gas to travel around the contact features and reach the cathode surface. At the same time, the larger contact area of the structural mesh layer distributes the weight of the cathode current collector over a larger percentage of the cathode surface. Thus, the numerous small contact features of the structural mesh layer create contacts/support while keeping the mean diffusion path under the cathode current collector-cathode surface contacts short, a feature that reduces transport resistance.

In various aspects, the structural mesh layer can have one or more (such as up to all) of the following features. The structural mesh layer can have a mesh contact area of 55% to 75%, or 55% to 70%, which corresponds to mesh open area of 25% to 45%, or 30% to 45%. Additionally or alternately, the structural mesh layer can have a cell density or opening density of 50 openings/cm² or more, or 75 openings/cm² or more, or 100 openings/cm² or more, or 125 openings/cm² or more, such as up to 1000 openings/cm² or possibly still higher. Further additionally or alternately, the structural mesh layer can have a thickness or height of at least 0.25 mm, or at least 0.30 mm, such as up to 0.80 mm or possibly still more.

It is noted that during operation, even with a structural mesh layer between the cathode surface and the cathode current collector, sufficient deformation of the cathode surface may occur for the cathode current collector to come into direct contact with the cathode, i.e., the cathode mesh under the current collector leg may be pressed sufficiently into the porous cathode surface so that the current collector leg can come into direct contact with the cathode. However, even if such deformation does occur, it is believed that the presence of the mesh structural layer can reduce or minimize the rate of such deformation and can still reinforce the current collector-cathode interface and thus increase the mechanical stability of the cell. It is further believed that this reduction in the rate of deformation can provide a corresponding decrease in the rate of increase of ohmic resistance over time and/or a corresponding decrease in the rate of loss of operating voltage over time. In this discussion, references to improvements in mechanical are structural stability are understood to be based on improved operation of a fuel cell over extended time (such as reducing the loss in operating voltage) due to the presence of a structural mesh layer as described herein.

### Definitions

Contact Area: The contact area of a structural mesh layer or a cathode current collector is defined herein as the percentage of a flat or level surface that is in contact with a structural mesh layer or cathode current collector when the structural mesh layer/cathode current collector is resting on the surface. It is noted that this definition represents an idealized amount of contact, as variations in a surface (such as a cathode surface) could result in increases or decreases in actual contact area. However, this idealized value is beneficial for comparing how a structural mesh layer or cathode current collector will interact with a cathode when the structural mesh layer/cathode current collector is resting on a cathode surface. Because the contact area is defined based on interaction of a structural mesh layer/cathode current collector with an idealized flat or level surface, the contact area is a property of the structural mesh layer/cathode current collector, and is well-defined even if the structural mesh layer or cathode current collector is not actually in contact with a level surface. When describing a structural mesh layer, the contact area can be referred to as a mesh contact area. When describing a cathode current collector, the contact area can be referred to as a cathode current collector contact area. The contact area of a structural mesh layer/cathode current collector can be expressed either as an absolute area, or as a percentage of the total area of the structural mesh layer/cathode current collector that would be in contact with a level surface. In this discussion, contact areas will typically be expressed as a percentage of the total area that would be in contact with a level surface.

Mesh Open Area or Cathode Collector Open Area: This value is the complement of the contact area. When the contact area for a structure is expressed as a percentage, the open area can be calculated as 100%−<contact area>. Alternatively, if it easier to characterize the areas of a level surface that would not be in contact with a structural mesh layer or a cathode current collector, the open area could be determined first, and then the contact area could be calculated based on 100%−<open area>.

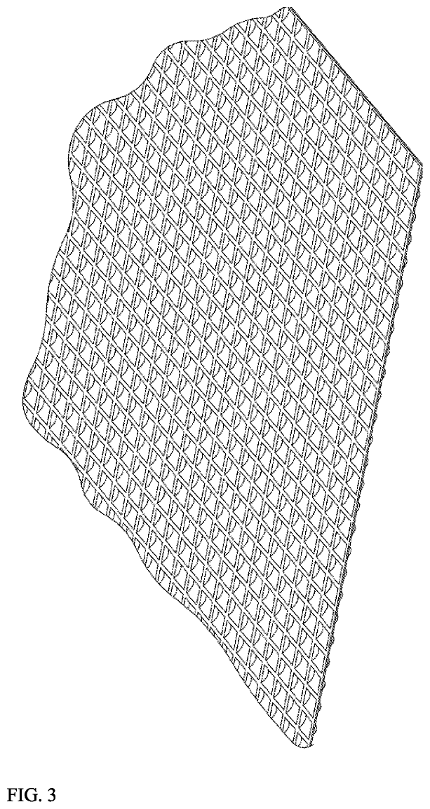

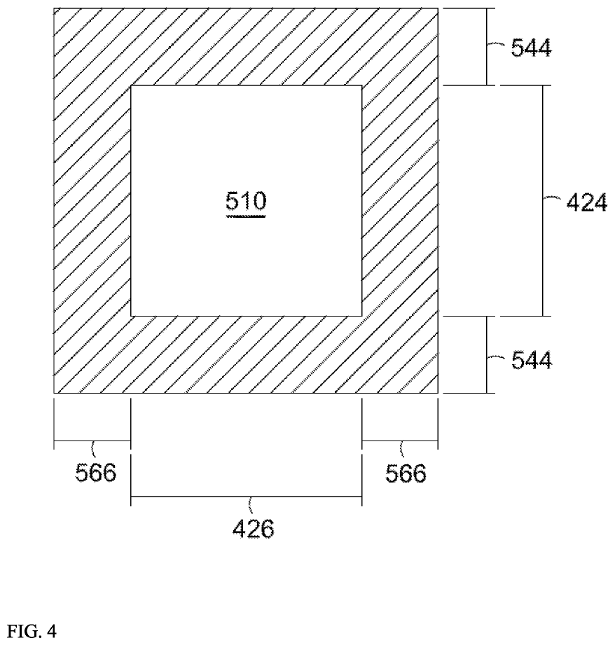

Calculation of Contact Area/Open Area: FIG. 4 shows an example of repeating units (i.e., unit cells) that can be used to represent the contact area of a cathode surface and open area for a cathode surface that is adjacent to a cathode current collector. Such a cathode surface can be in contact with the cathode current collector (no structural mesh layer) or can be in contact with a structural mesh layer that is disposed between the cathode surface and the cathode current collector. The example repeat unit in FIG. 4 corresponds to the repeating pattern (unit cell) that can be used to represent a cathode current collector structure such as the structure shown in FIG. 3. In FIG. 4, the patterned area corresponds to the area where the collector is in contact with the cathode surface, while the open area corresponds to an area where gas can pass between the cathode and the collector. In the calculation below, the open area is calculated, and then the contact area can be determined as 100%−<open area>. It is understood that this for convenience, and instead the contact area could be calculated first, followed by determining open area as 100%−<contact area>.

A calculation can be performed to calculate the open area of the central area 510, which is open in this example, for the repeat pattern shown in FIG. 4. In FIG. 4, distance 424 can be set to 8.0, distance 544 can be set to 1.0, distance 426 can be set to 8.0, and distance 566 can be set to 1.0. This results in an open area of 64/100, or 64%. This can be determined, for example, by noting that the area of open area is 8.0*8.0=64, while the area of the total repeating unit is (1.0+8.0+1.0)*(1.0+8.0+1.0)=10. It is noted that the distances in FIG. 4 are normalized, and therefore are in arbitrary length units. It is also noted that selection of different relative values for the distances 424, 426, 544, and 566 can allow for corresponding selection of patterns with various amounts of open area. It is further noted that similar calculations could be performed for patterns where the central area 510 corresponds to the blocked area, and the area surrounding central area 510 corresponds to the open area. For example, if the cathode current collector structure shown in FIG. 3 is used so that the loop structures are in contact with the cathode surface, the open area calculation could be performed by using central area 510 as the blocked area (where the loops contact the cathode) and the surrounding area as the open area.

The contact area of a cathode surface corresponds to the remaining portion of the cathode surface that does not correspond to open area of the cathode surface. Thus, one option for calculating the contact area of a cathode surface is to subtract the open area of the cathode surface from 100%. For the above example, this would correspond to a contact area of 100%−64%=36%.

It is noted that open area of a cathode surface is defined independently of the presence or absence of a structural mesh layer. The presence of a structural mesh layer does not alter the calculated value for open area of a cathode surface. In various aspects, when a structural mesh layer is disposed between a cathode surface and a cathode current collector, the mesh open area of the structural mesh layer can be less than the open area of the cathode surface, as defined by the cathode current collector.

Average cathode gas lateral diffusion length: The average cathode gas lateral diffusion length is defined as the average lateral distance from an open area location on a cathode surface to each point on the cathode surface. For the purposes of this definition, the lateral diffusion length for any point corresponding to an open area location is defined as zero.

The average cathode gas lateral diffusion length can also be calculated for cathode surfaces having a repeating pattern, such as the repeating pattern shown in FIG. 4. The same normalized distances shown FIG. 4 can be used, with the end result being multiplied by an appropriate scaling factor to represent a given configuration.

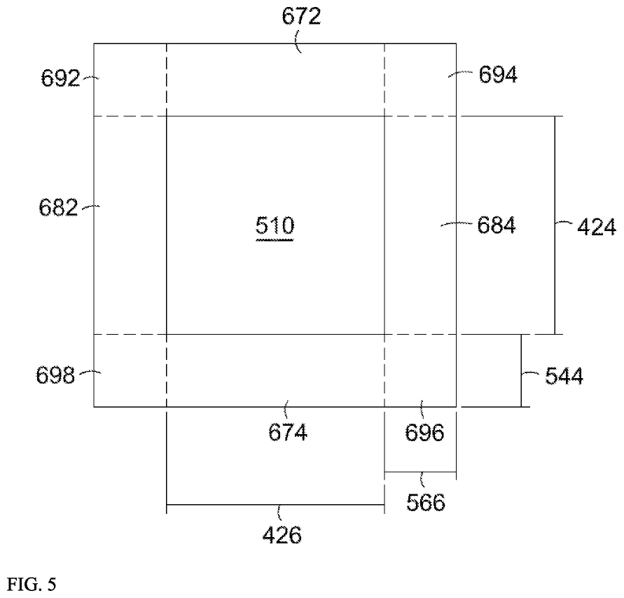

One option for determining the average cathode gas lateral diffusion length can be to directly calculate the value, based on a repeating pattern element, such as by using a commercially available software package. Additionally, relatively good approximate values can be determined in a straightforward manner FIG. 5 shows another example of the repeating pattern element shown in FIG. 4. (Shading is not used in FIG. 5 to designate open area versus contact area.) In FIG. 5, the region around central area 510 can be divided into several pieces. For lateral areas 672 and 674, the average distance from an open area is simply half of the length of the lateral area, or 0.5. Similarly, for vertical areas 682 and 684, the average distance from an open area is half of the width of the vertical area, or 0.5. For corner areas 692, 694, 696, and 698, an upper limit for the average distance can be determined based on the maximum distance, or the distance from the open area to the top corner of the square. Half of that maximum distance is roughly 0.7, which provides a bounding upper limit for the average distances within corner areas 692, 694, 696, and 696.

The above average distances can then be used to determine the average cathode gas lateral diffusion length by multiplying the average distances by the percentage of the total area corresponding to each distance. Areas 672, 674, 682, and 684 correspond to 32% of the total area of the repeat pattern unit shown in FIG. 5. The corner areas correspond to 4% of the total area. The remaining 64% of the area corresponds to the open central area 510, which by definition has a distance of zero. These values can be used to determine an upper limit for the average cathode gas lateral diffusion length of (0.64*0+0.32*0.5+0.04*0.7)=0.188. The 0.188 value can then be multiplied by a scaling factor that is representative of a real system. As an example, a scaling factor of 0.635 mm can be used. Multiplying 0.188 by a scaling factor of 0.635 mm results in an average cathode gas lateral diffusion length of 0.12 mm. It is noted that based on the assumptions used when calculating the average distance values for corner areas 692, 694, 696, and 698, the value of 0.12 mm represents an upper bound for the actual average cathode gas lateral diffusion length.

Average contact area diffusion length: The average contact area diffusion length is defined as the average lateral distance from a contact area location on a cathode surface to each point on the cathode surface. For the purposes of this definition, the contact area diffusion length for any point corresponding to a contact area location is defined as zero. An example of this calculation will be further illustrated below.

Fuel cell and fuel cell stack definitions: In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can represent a plurality of cells in an integrated unit. Although a fuel cell stack can include multiple fuel cells, the fuel cells can typically be connected in parallel and can function (approximately) as if they collectively represented a single fuel cell of a larger size. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the electrical currents in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (i.e., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

### Fuel Cell Structure Including Structural Mesh Layer

In various aspects, a structural mesh layer can be included in a molten carbonate fuel cell structure that also includes a cathode current collector that would provide a reduced contact area/an increased amount of open area. For example, in some aspects, a fuel cell can have a cathode current collector that has a contact area (when in contact with an idealized level or flat surface) of 55% or less, or 50% or less, or 40% or less, or 30% or less, such as down to 5% or possibly still lower. This corresponds to an open area of 45% or more, or 50% or more, or 60% or more, or 70% or more, such as up to 95% or possibly still higher. In such a fuel cell structure, a structural mesh layer can be used that has one or more of the following features. In some aspects, the structural mesh layer can have a contact area of 55% to 75%, or 55% to 70%, which corresponds to a mesh open area of 25% to 45%, or 30% to 45%. Additionally or alternately, the structural mesh layer can have a cell density or opening density of 50 openings/cm² or more, or 75 openings/cm² or more, or 100 openings/cm² or more, or 125 openings/cm² or more, such as up to 1000 openings/cm² or possibly still higher. Although the mesh open area of the structural mesh layer is lower than the open area of the cathode surface (as defined by the cathode current collector), it is believed that the large plurality of openings in the mesh structure allows the fuel cell to maintain high selectivity for carbonate ion transport across the electrolyte matrix.

A structural mesh layer can be formed in any convenient manner. In some aspects, the structural mesh layer can correspond to a traditional mesh, with wires defining a square grid of openings having a target density of openings and providing a target open mesh area. In other aspects, the structural mesh layer can be formed as a perforated plate that contains a substantially regular set of openings to provide a target density of openings and providing a target open mesh area. More generally, any convenient method for forming a structure that has an opening density of 50 openings/cm² or more and a mesh open area of 25% to 45% (contact area of 55% to 75%) can be used to form a structural mesh layer.

It is noted that the combination of having a relatively low mesh open area (25% to 45%) while also having a high density of openings (50 openings/cm² or more) allows the mesh to serve as a structural support. This is in contrast to a mesh layer having a mesh open area of 50% or more, where the large amount of mesh open area reduces or minimizes the ability of a mesh to also provide structural support. Instead, it is believed that having a mesh open area of 50% or more provides insufficient structural stability, so that the difficulties with cathode deformation, matrix deformation, and/or increased scale build-up still occur even with the presence of a mesh.

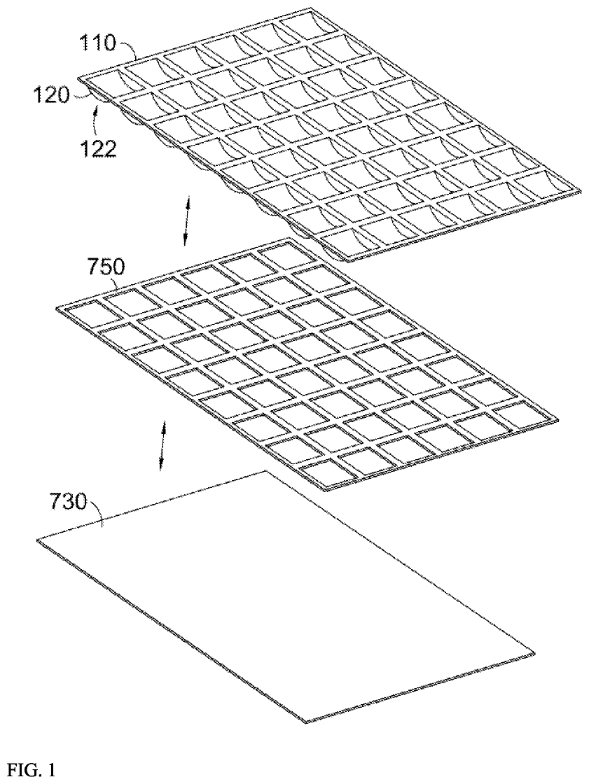

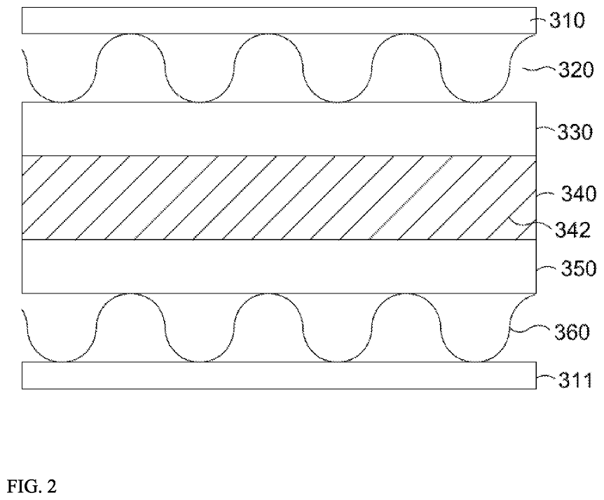

The structural mesh layer can be described in relation to a typical structure for a molten carbonate fuel cell. FIG. 2 shows a general example of a portion of a molten carbonate fuel cell stack which substantially corresponds to a single fuel cell. The portion of the stack shown in FIG. 2 corresponds to a fuel cell 301. In order to isolate the fuel cell from adjacent fuel cells in the stack and/or other elements in the stack, the fuel cell includes separator plates 310 and 311. In FIG. 2, the fuel cell 301 includes an anode 330 and a cathode 350 that are separated by an electrolyte matrix 340 that contains an electrolyte 342. In various aspects, cathode 350 can correspond to a dual-layer (or multi-layer) cathode. Anode collector 320 provides electrical contact between anode 330 and the other anodes in the stack, while cathode current collector 360 provides similar electrical contact between cathode 350 (via the structural mesh layer) and the other cathodes in the fuel cell stack. Additionally anode collector 320 allows for introduction and exhaust of gases from anode 330, while cathode current collector 360 allows for introduction and exhaust of gases from cathode 350. In various aspects, a structural mesh layer (such as layer 750 from FIG. 1) can be disposed between cathode 350 and cathode current collector 360. It is noted that FIG. 3 shows an example of a configuration for a cathode current collector 360.

During operation, CO₂ is passed into the cathode current collector 360 along with O₂. The CO₂ and O₂ diffuse into the porous cathode 350 and travel to a cathode interface region near the boundary of cathode 350 and electrolyte matrix 340. In the cathode interface region, a portion of electrolyte 342 can be present in the pores of cathode 350. The CO₂ and O₂ can be converted near/in the cathode interface region to carbonate ion (CO₃²⁻), which can then be transported across electrolyte 342 (and therefore across electrolyte matrix 340) to facilitate generation of electrical current. After transport across the electrolyte 342, the carbonate ion can reach an anode interface region near the boundary of electrolyte matrix 340 and anode 330. The carbonate ion can be converted back to CO₂ and H₂O in the presence of H₂, releasing electrons that are used to form the current generated by the fuel cell. The H₂ and/or a hydrocarbon suitable for forming H₂ are introduced into anode 330 via anode collector 320.

Conventionally, a cathode current collector structure, such as the structure 110 shown in FIG. 1 would be oriented so that the plate-like surface is in contact with the cathode surface. In various aspects, instead of using a conventional configuration, a cathode current collector (such as the structure shown in FIG. 1) can be oriented so that the bottom edges 122 of the loop structures 120 are in contact with the cathode surface, while the plate-like surface is in contact with the separator plate.

FIG. 1 shows an example of how the fuel cell/portion of a fuel cell stack shown in FIG. 2 can be modified to include a structural mesh component or layer. In the example shown in FIG. 1, the bottom edges 122 of loop structures 120 are the locations where the cathode current collector 110 is intended to provide electrical contact with the cathode surface 730. In a fuel cell where structural mesh layer 750 is not present, having bottom edges 122 of loop structures 120 as the contact points with the cathode surface 730 can reduce the blocked area/increase the open area of the cathode surface 730, based on the cathode current collector having a contact area of 55% or less, or 50% or less, or 40% or less, or 30% or less, such as down to 5% or possibly still lower. (This would correspond to an open area of the cathode surface 730 of 45% or more, or 50% or more, or 60% or more, or 70% or more, such as up to 95% or possibly still higher.) Unfortunately, placing a cathode current collector 110 with such a low contact area directly in contact with a cathode surface 730 can result in reduced cell voltage and/or increased ohmic resistance over time.

Instead of having the cathode current collector make contact directly with the cathode surface 730, a structural mesh layer 750 can be disposed between the cathode current collector 110 and the cathode surface 730. In the configuration shown in FIG. 1, the cathode current collector 110 can rest on/make contact with structural mesh layer 750. The structural mesh layer 750 then provides electrical contact between the cathode current collector 110 and cathode surface 730. By placing structural mesh layer 750 between cathode current collector 110 and cathode surface 730, it is believed that the pressure exerted by the cathode current collector on cathode surface 730 is distributed more evenly across the cathode surface 730, thus reducing or minimizing any deformation of the cathode surface. For example, for the configuration shown in FIG. 1, bottom edges 122 of loop structures 120 can be in contact with structural mesh layer 750. This reduces or minimizes deformation of the cathode surface 730 due to direct contact with the loop structures 120. Instead, the pressure exerted by the loop structures 120 of cathode current collector 110 is distributed across the cathode surface 730. Due to the high density of openings in the structural mesh layer, it has been discovered that the favorable gas transport properties of using a cathode current collector that provides an increased open area at the cathode surface can also be maintained.

It is noted that based on the small mesh size of the structural mesh layer 750, the average contact area diffusion length can also be greatly reduced. For example, with a mesh size of 1.0 mm or less (roughly 100 openings/cm² or more), the corresponding average contact area diffusion length can be reduced to 0.3 mm or less.

Depending on the aspect, the structural mesh layer can have a thickness (height) of roughly 0.25 mm to 0.80 mm (˜0.01 inches to ˜0.03 inches). The structural mesh layer can be made of any convenient material that is relatively chemically inert under the conditions present at the cathode/cathode current collector interface. Various types of stainless steel are examples of suitable materials.

### Example of Molten Carbonate Fuel Cell Operation: Cross Flow Orientation for Cathode and Anode

The flow direction within the anode of a molten carbonate fuel cell can have any convenient orientation relative to the flow direction within a cathode. One option can be to use a co-current or counter-current flow configuration. Using co-current flow or counter-current flow can assist with providing higher uniformity in gas concentrations within a fuel cell. However, using co-current or counter-current flow can increase the complexity of the gas flow management. U.S. Patent Application Publication 2021/0159523 describes examples of how to manage the flows to a fuel cell when operated in co-current or counter-current mode.

Another option can be to use a cross-flow configuration, so that the flow direction within the anode is roughly at a 90° angle relative to the flow direction within the cathode. This type of flow configuration can have practical benefits, as using a cross-flow configuration can allow the manifolds and/or piping for the anode inlets/outlets to be located on different sides of a fuel cell stack from the manifolds and/or piping for the cathode inlets/outlets.

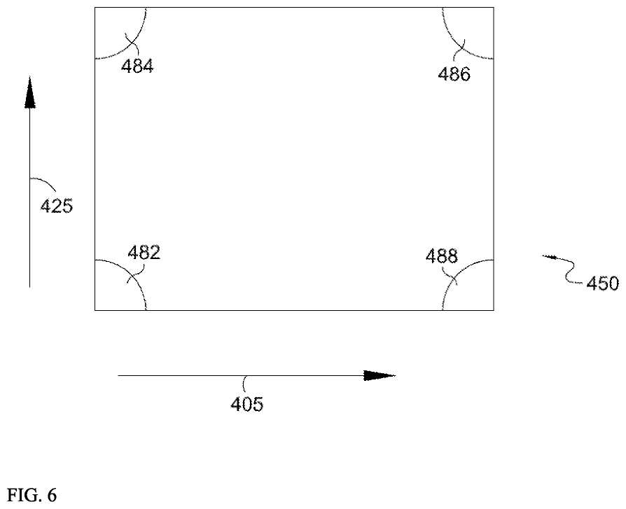

FIG. 6 schematically shows an example of a top view for a fuel cell cathode, along with arrows indicating the direction of flow within the fuel cell cathode and the corresponding fuel cell anode. In FIG. 6, arrow 405 indicates the direction of flow within cathode 450, while arrow 425 indicates the direction of flow with the anode (not shown).

Because the anode and cathode flows are oriented at roughly 90° relative to each other, the anode and cathode flow patterns can contribute to having different reaction conditions in various parts of the cathode. Corner 482 corresponds to a portion of the fuel cell that is close to the entry point for both the cathode input flow and the anode input flow. As a result, the concentration of both CO₂ (in the cathode) and H₂ (in the anode) can be relatively high in corner 482, depending on the fuel utilization and the CO₂ utilization. Corner 484 corresponds to a portion of the fuel cell that is close to the entry point for the cathode input flow and close to the exit point for the anode output flow. In locations near corner 484, the concentration of H₂ (in the anode) may be reduced under some conditions, while the CO₂ concentration may be relatively higher. Corner 486 corresponds to a portion of the fuel cell that is close to the exit point for the anode output flow and close to the exit point for the cathode output flow. In locations near corner 486, the concentrations of both H₂ (in the anode) and CO₂ (in the cathode) can potentially be lower, depending on the operating conditions for the fuel cell. Corner 488 corresponds to a portion of the fuel cell that is close to the entry point for the anode input flow and close to the exit point for the cathode output flow. In locations near corner 484, the concentration of H₂ (in the anode) may be increased under some conditions, while the CO₂ concentration may be relatively lower.

### Anode Inputs and Outputs

In various aspects, the anode input stream for a MCFC can include hydrogen, a hydrocarbon such as methane, a hydrocarbonaceous or hydrocarbon-like compound that may contain heteroatoms different from C and H, or a combination thereof. The source of the hydrogen/hydrocarbon/hydrocarbon-like compounds can be referred to as a fuel source. In some aspects, most of the methane (or other hydrocarbon, hydrocarbonaceous, or hydrocarbon-like compound) fed to the anode can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane.

The fuel source used can be shared with other components, such as a turbine that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate H₂, the molar ratio of water to fuel can be from about one to one to about ten to one, such as at least about two to one. A ratio of four to one or greater is typical for external reforming, but lower values can be typical for internal reforming. To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an anode input stream for the anode of a molten carbonate fuel cell. Some fuel streams can correspond to streams containing hydrocarbons and/or hydrocarbon-like compounds that may also include heteroatoms different from C and H. In this discussion, unless otherwise specified, a reference to a fuel stream containing hydrocarbons for an MCFC anode is defined to include fuel streams containing such hydrocarbon-like compounds. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be at least about 1 vol %, such as at least about 2 vol %, or at least about 5 vol %, or at least about 10 vol %, or at least about 15 vol %, or at least about 20 vol %, or at least about 25 vol %, or at least about 30 vol %, or at least about 35 vol %, or at least about 40 vol %, or at least about 45 vol %, or at least about 50 vol %, or at least about 75 vol %. Additionally or alternately, the amount of CO₂ and/or inert compounds in a fuel stream for a molten carbonate fuel cell can be about 90 vol % or less, such as about 75 vol % or less, or about 60 vol % or less, or about 50 vol % or less, or about 40 vol % or less, or about 35 vol % or less.

Yet other examples of potential sources for an anode input stream can correspond to refinery and/or other industrial process output streams. For example, coking is a common process in many refineries for converting heavier compounds to lower boiling ranges. Coking typically produces an off-gas containing a variety of compounds that are gases at room temperature, including CO and various C₁-C₄ hydrocarbons. This off-gas can be used as at least a portion of an anode input stream. Other refinery off-gas streams can additionally or alternately be suitable for inclusion in an anode input stream, such as light ends (C₁-C₄) generated during cracking or other refinery processes. Still other suitable refinery streams can additionally or alternately include refinery streams containing CO or CO₂ that also contain H₂ and/or reformable fuel compounds.

Still other potential sources for an anode input can additionally or alternately include streams with increased water content. For example, an ethanol output stream from an ethanol plant (or another type of fermentation process) can include a substantial portion of H₂O prior to final distillation. Such H₂O can typically cause only minimal impact on the operation of a fuel cell. Thus, a fermentation mixture of alcohol (or other fermentation product) and water can be used as at least a portion of an anode input stream.

Biogas, or digester gas, is another additional or alternate potential source for an anode input. Biogas may primarily comprise methane and CO₂ and is typically produced by the breakdown or digestion of organic matter. Anaerobic bacteria may be used to digest the organic matter and produce the biogas. Impurities, such as sulfur-containing compounds, may be removed from the biogas prior to use as an anode input.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

### Cathode Inputs and Outputs

Conventionally, a molten carbonate fuel cell can be operated based on drawing a desired load while consuming some portion of the fuel in the fuel stream delivered to the anode. The voltage of the fuel cell can then be determined by the load, fuel input to the anode, air and CO₂ provided to the cathode, and the internal resistances of the fuel cell. The CO₂ to the cathode can be conventionally provided in part by using the anode exhaust as at least a part of the cathode input stream. By contrast, the present invention can use separate/different sources for the anode input and cathode input. By removing any direct link between the composition of the anode input flow and the cathode input flow, additional options become available for operating the fuel cell, such as to generate excess synthesis gas, to improve capture of carbon dioxide, and/or to improve the total efficiency (electrical plus chemical power) of the fuel cell, among others.

One example of a suitable CO₂-containing stream for use as a cathode input flow can be an output or exhaust flow from a combustion source. Examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air). Depending on the aspect, the CO₂ utilization in the fuel cell can be 50% or more, or 70% or more, or 80% or more, or 90% or more, such as up to 98% or possibly still higher. It is noted that molten carbonate fuel cells used in conventional configurations for power generation typically operate with a CO₂ utilization below 70%. By contrast, the benefits of including a structural mesh layer can also be realized when using a fuel cell to perform other applications, such as using a fuel cell to achieve a target level of carbon capture. In such aspects, the CO₂ utilization can be 70% to 98%, or 75% to 98%, or 80% to 98%. In some aspects, the CO₂ content of the cathode input stream can be 3.0 vol % to 20 vol %, or 3.0 vol % to 15 vol %, or 5.0 vol % to 20 vol %, or 5.0 vol % to 15 vol %, or 10 vol % to 20 vol %. In other aspects, such as some aspects where the cathode input stream is based on a flue gas from a natural gas-fired power plant, the CO₂ content of the cathode input stream can be 5.0 vol % or less, or 4.0 vol % or less, such as 1.5 vol % to 5.0 vol %, or 1.5 vol % to 4.0 vol %, or 2.0 vol % to 5.0 vol %, or 2.0 vol % to 4.0 vol %. In some aspects, the CO₂ content of the cathode output stream can be 1.5 vol % or less, or 1.0 vol % or less, such as down to 0.1 vol % or possibly still lower.

Other potential sources for a cathode input stream can additionally or alternately include sources of bio-produced CO₂. This can include, for example, CO₂ generated during processing of bio-derived compounds, such as CO₂ generated during ethanol production. An additional or alternate example can include CO₂ generated by combustion of a bio-produced fuel, such as combustion of lignocellulose. Still other additional or alternate potential CO₂ sources can correspond to output or exhaust streams from various industrial processes, such as CO₂-containing streams generated by plants for manufacture of steel, cement, and/or paper.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

In addition to CO₂, a cathode input stream can include O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of about 20 vol % or less, such as about 15 vol % or less, or about 10 vol % or less. Additionally or alternately, the oxygen content of the cathode input stream can be at least about 4 vol %, such as at least about 6 vol %, or at least about 8 vol %. More generally, a cathode input stream can have a suitable content of oxygen for performing the cathode reaction. In some aspects, this can correspond to an oxygen content of about 5 vol % to about 15 vol %, such as from about 7 vol % to about 9 vol %. For many types of cathode input streams, the combined amount of CO₂ and O₂ can correspond to less than about 21 vol % of the input stream, such as less than about 15 vol % of the stream or less than about 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be at least about 78 vol %, e.g., at least about 88 vol %, and/or about 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants.

A suitable temperature for operation of an MCFC can be between about 450° C. and about 750° C., such as at least about 500° C., e.g., with an inlet temperature of about 550° C. and an outlet temperature of about 625° C. Prior to entering the cathode, heat can be added to or removed from the cathode input stream, if desired, e.g., to provide heat for other processes, such as reforming the fuel input for the anode. For example, if the source for the cathode input stream is a combustion exhaust stream, the combustion exhaust stream may have a temperature greater than a desired temperature for the cathode inlet. In such an aspect, heat can be removed from the combustion exhaust prior to use as the cathode input stream. Alternatively, the combustion exhaust could be at very low temperature, for example after a wet gas scrubber on a coal-fired boiler, in which case the combustion exhaust can be below about 100° C. Alternatively, the combustion exhaust could be from the exhaust of a gas turbine operated in combined cycle mode, in which the gas can be cooled by raising steam to run a steam turbine for additional power generation. In this case, the gas can be below about 50° C. Heat can be added to a combustion exhaust that is cooler than desired.

### Examples

A series of lab scale individual fuel cells were tested that included various types of configurations at the interface between the cathode surface and the cathode current collector. The lab scale fuel cells each had a 250 cm² of active surface area. The cathode current collector in the fuel cells had a structure corresponding to a contact area of 10%/an open area at the cathode surface of 90%. Some fuel cells did not have a mesh layer between the cathode current collector and the cathode surface. Other fuel cells had a structural mesh layer with varying densities of openings in the mesh and that provided varying amounts of mesh open area. Generally in these examples, the fuel cells were operated at various conditions that ranged from 4.0 vol % to 10 vol % CO₂ in the cathode inlet gas; a current density of 140 mA/cm² to 180 mA/cm²; and a CO₂ utilization between 65% and 98%.

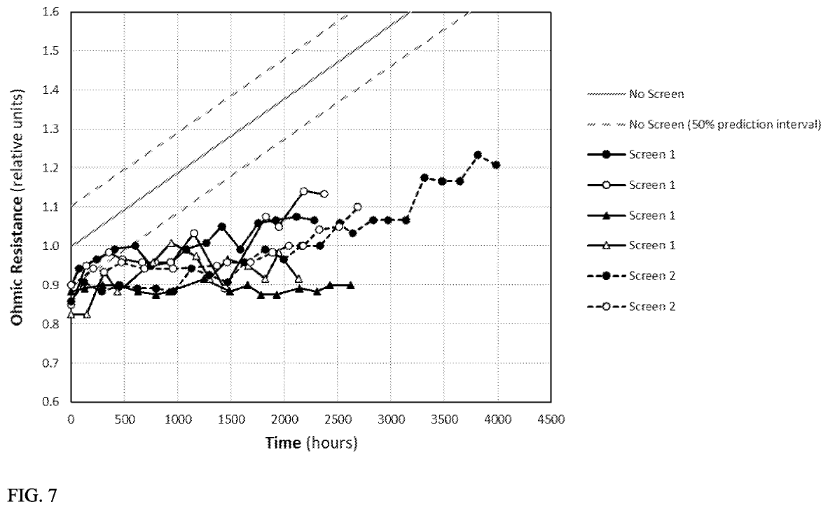

In a first set of test runs, fuel cell operation was compared for fuel cells that did not have a mesh layer versus fuel cells that included a structural mesh layer having an opening density of 100 openings/cm² or more and a mesh open area of 25% to 45% (contact area of 55% to 75%). A plurality of cells were operated using both types of configurations. For the runs shown in FIG. 7, the cells were operated at a CO₂ utilization of roughly 90%. FIG. 7 shows the ohmic resistance for the cells over an extended run length. Each line in FIG. 7 corresponds to data from operation of a single fuel cell. As shown in FIG. 7, the cells without a mesh layer initially had an ohmic resistance that was similar to the ohmic resistance for the cells that included a mesh layer. However, the ohmic resistance quickly increased with time during operation of the fuel cells that did not have a mesh layer. By contrast, the cells that included the structural mesh layer unexpectedly maintained the substantially the same ohmic resistance value over the full course of the runs.

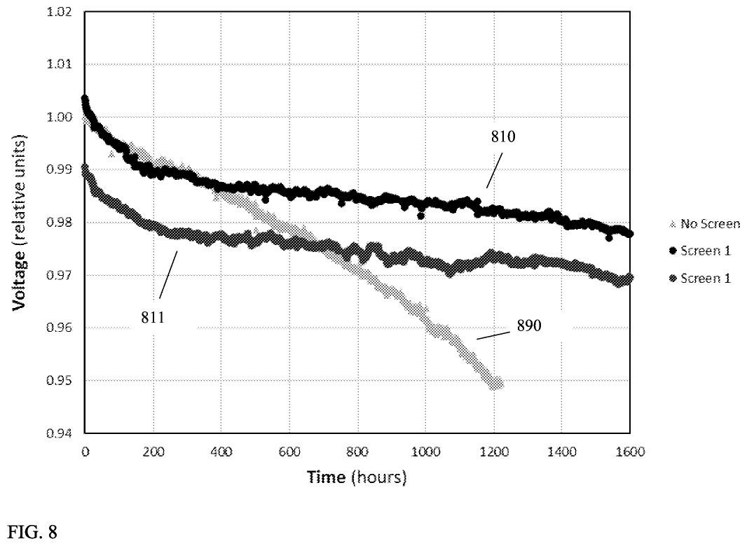

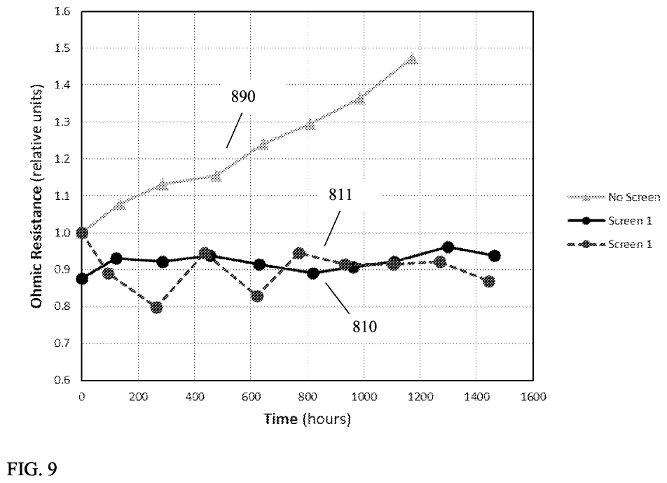

FIG. 8 and FIG. 9 illustrate the impact of the increased ohmic resistance on fuel cell performance FIG. 9 corresponds to the same type of plot as FIG. 7, but for fuel cells operated at roughly 70% CO₂ utilization. For clarity only one fuel cell without a mesh layer is shown (line 890), along with only two of fuel cells including the mesh layer are shown (lines 810 and 820). FIG. 8 shows how the changes in ohmic resistance modify the operating voltage of the fuel cell. As shown in FIG. 8, the increasing ohmic resistance over time for the fuel cell without a mesh screen results in a substantial drop in operating voltage. By contrast, the fuel cells including the mesh layer unexpectedly maintained substantially the same operating voltage over time at the selected operating conditions.

FIGS. 7, 8, and 9 compare operation of fuel cells without a mesh versus fuel cells that include a structural mesh layer having a high density of openings and a low mesh open area. Additional test runs were performed to determine the types of mesh layers that can provide the benefits shown in FIGS. 7, 8, and 9. The additional test runs were performed at two different types of operating conditions. For both types of operating conditions, the CO₂ utilization was varied in different runs to determine how operating voltage and ohmic resistance changed as the CO₂ utilization changed.

Table 1 shows the six different types of mesh layers that were tested in various runs. Table 1 shows the mesh open area, the density of openings, and thickness for each mesh layer. In Table 1, mesh layers 3-6 correspond to comparative mesh layers that have insufficient mesh open area and/or insufficient density of openings to provide the unexpected benefits.

TABLE 1
Characteristics of Mesh Layers

| | Mesh Open Area/ | Opening Density | |
|---|---|---|---|
| Mesh | Contact Area | (openings/cm²) | Thickness (mm) |
| 1 | 30.5%/69.5% | 558 | <0.38 |
| 2 | 40.8%/59.2% | 140 | <0.61 |
| 3 | 51.8%/48.2% | 122 | <0.51 |
| 4 | 78%/22% | 10.9 | 0.25 |
| 5 | 60.5%/39.5% | 2.6 | 0.30 |
| 6 | 60.5%/39.5% | 5.3 | 0.30 |

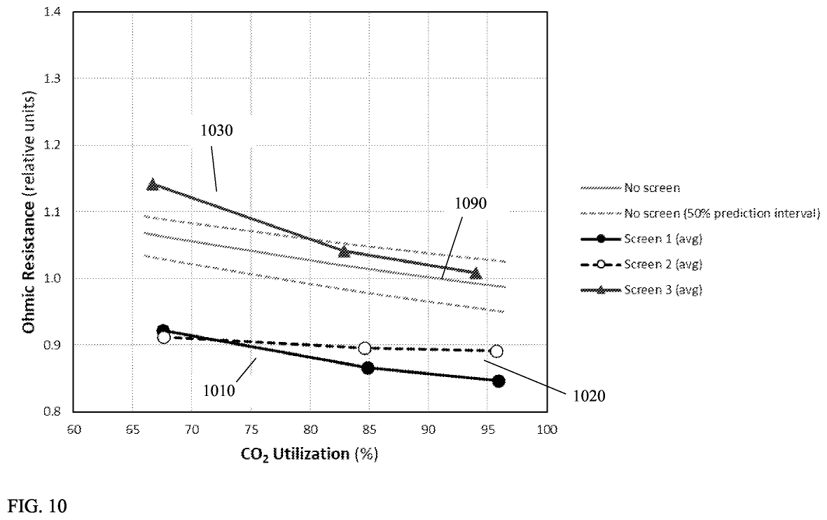

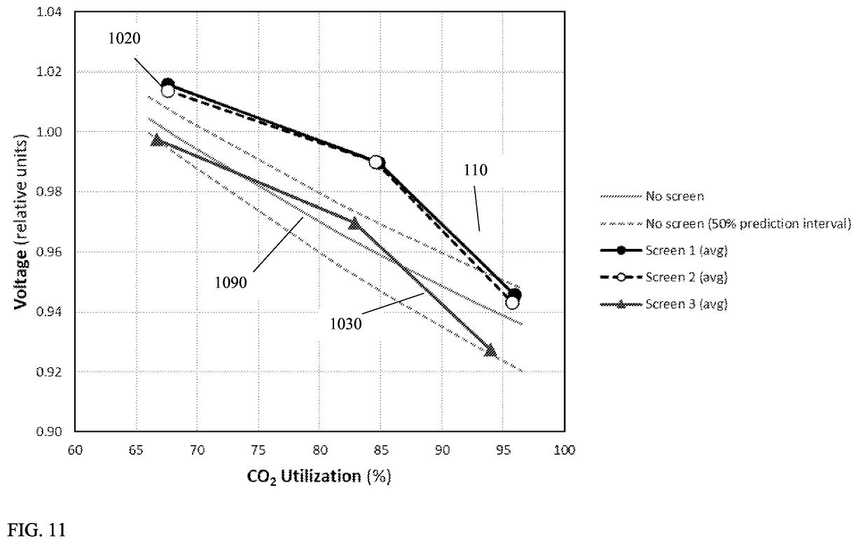

Fuel cells including mesh layers based on Mesh 1, Mesh 2, and Mesh 3 were operated under the first set of conditions at various levels of CO₂ utilization. FIG. 10 shows how the ohmic resistance varied with CO₂ utilization, while FIG. 11 shows the operating voltage versus CO₂ utilization. The values shown in FIG. 10 and FIG. 11 represent average values obtained while maintaining operation of a plurality of fuel cells for a period of time at a specified CO₂ utilization level.

As shown in FIG. 10, the cell including Mesh 1 (line 1010) and the cell including Mesh 2 (line 1020) both showed a substantial decrease in ohmic resistance relative to a cell including no mesh layer (line 1090). For comparison purposes, error bars are also provided for line 1090, the cell without a mesh layer, to demonstrate that the differences in ohmic resistance shown in FIG. 10 for Mesh 1 and Mesh 2 are not merely due to expected levels of variance in fuel cell behavior. By contrast, the cell including comparative Mesh 3 (line 1030) had an ohmic resistance comparable to the ohmic resistance for the cell including no mesh layer (line 1090). It is noted that comparative Mesh 3 had a relatively high density of openings. However, the mesh open area for comparative Mesh 3 was too high.

FIG. 11 shows similar trends for the operating voltage relative to CO₂ utilization. As shown in FIG. 11, the cells including Mesh 1 and Mesh 2 had higher operating voltage than the cell without a mesh layer. The cell including comparative Mesh 3 had a similar operating voltage to the cell without a mesh layer.

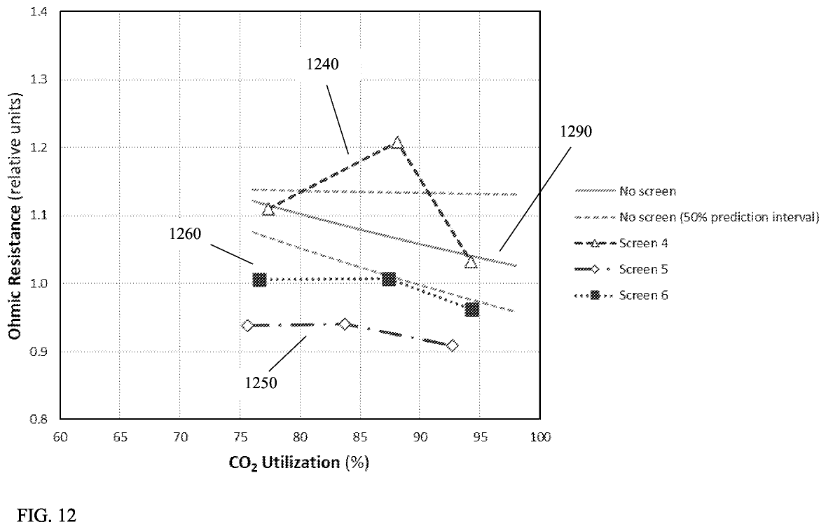

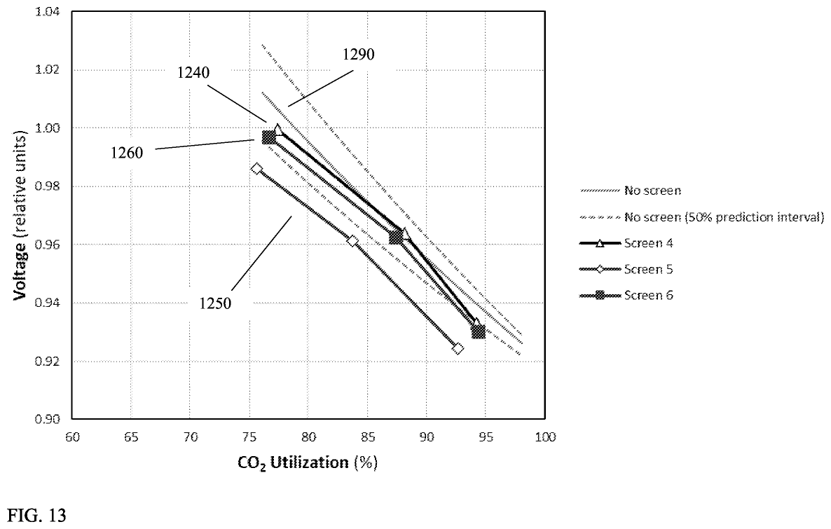

Additional tests were performed using the second set of operating conditions for cells including comparative Mesh 4, comparative Mesh 5, and comparative Mesh 6. FIG. 12 shows ohmic resistance versus CO₂ utilization, while FIG. 13 shows the operating voltage versus CO₂ utilization. Again, the data in FIG. 12 and FIG. 13 represents average values based on operation of multiple cells with identical configuration.

As shown in FIG. 12, the cells including comparative Mesh 5 (line 1250) and comparative Mesh 6 (line 1260) actually showed a reduction in ohmic resistance relative to the cell with no mesh layer (line 1290). The cell including comparative Mesh 4 (line 1240) had an ohmic resistance similar to the cell with no mesh layer (line 1290).

Although the cells including comparative Mesh 5 and comparative Mesh 6 had reduced ohmic resistance, those cells did not achieve a corresponding benefit in operating voltage. As shown in FIG. 13, the cells including comparative Mesh 5 and comparative Mesh 6 appeared to have similar or possibly even lower operating voltage relative to the cells without a mesh layer. Without being bound by any particular theory, it is believed that the low density of openings results in shadowing and poor transport of CO₂ from cathode current collector to cathode, even though the mesh open area is relatively high.

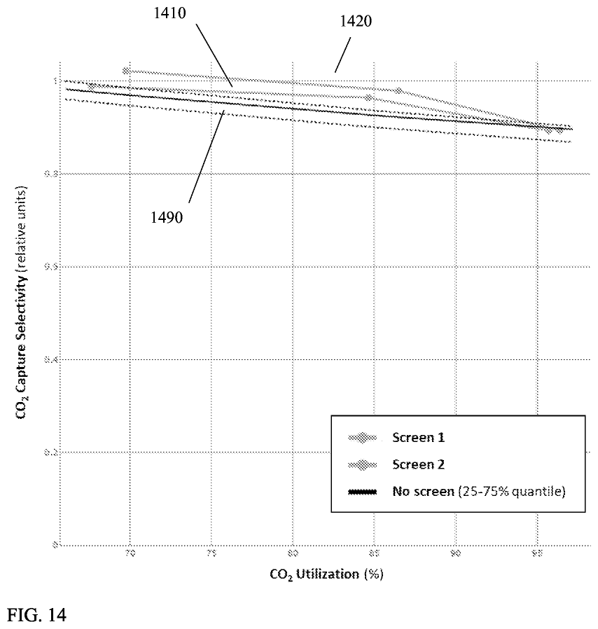

Based on the results from FIGS. 7-13, using a structural mesh layer with a relatively low mesh open area and a relatively high density of openings can allow for improved operation of a fuel cell over time. As a further confirmation, FIG. 14 shows results from additional runs that were performed using cells containing Mesh 1, Mesh 2, and no mesh layer. In the additional runs, the transference for the cell was measured as a function of CO₂ utilization. Transference refers to the fraction of ions transported across the electrolyte matrix that correspond to carbonate ions (transport of CO₂), as opposed to other types of ions such as hydroxide ions. As shown in FIG. 14, the addition of Mesh 1 (1410) or Mesh 2 (1420) to the cell resulted in substantially the same or possibly higher levels of transference as the cell without the mesh (1490).

### Additional Embodiments

Embodiment 1. A molten carbonate fuel cell, comprising: an anode; a first separator plate; an anode collector in contact with the anode and the first separator plate to define an anode gas collection zone between the anode and the first separator plate; a cathode having a cathode surface; a second separator plate; a cathode current collector in contact with the second separator plate and adjacent to the cathode surface to define a cathode gas collection zone between the cathode and the second separator plate, the cathode current collector having a contact area of less than 55%; a structural mesh layer disposed between the cathode surface and the cathode current collector, the structural mesh layer comprising 50 openings/cm² or more and having a mesh contact area of 55% to 75%; and an electrolyte matrix comprising an electrolyte between the anode and the cathode.
Embodiment 2. The molten carbonate fuel cell of Embodiment 1, wherein the structural mesh layer comprises 75 openings/cm² or more.
Embodiment 3. The molten carbonate fuel cell of any of the above embodiments, wherein the structural mesh layer comprises 125 openings/cm² or more.
Embodiment 4. The molten carbonate fuel cell of any of the above embodiments, wherein the contact area of the cathode current collector is 50% or more.
Embodiment 5. The molten carbonate fuel cell of any of the above embodiments, wherein the structural mesh layer provides electrical contact between the cathode current collector and the cathode surface.
Embodiment 6. The molten carbonate fuel cell of any of the above embodiments, wherein an average contact area diffusion length is 1.0 mm or less, or wherein the average cathode gas lateral diffusion length is 0.35 mm or less, or a combination thereof.
Embodiment 7. The molten carbonate fuel cell of any of the above embodiments, wherein the structural mesh layer comprises a thickness of 0.25 mm to 0.80 mm
Embodiment 8. The molten carbonate fuel cell of any of the above embodiments, wherein the structural mesh layer is composed of stainless steel.
Embodiment 9. A method for producing electricity in a molten carbonate fuel cell according to any of Embodiments 1-8, comprising: introducing an anode input stream comprising H₂, a reformable fuel, or a combination thereof into the anode gas collection zone; introducing a cathode input stream comprising O₂ and CO₂ into the cathode gas collection zone; and operating the molten carbonate fuel cell at an average current density of 60 mA/cm² or more to generate electricity, an anode exhaust, and a cathode exhaust.
Embodiment 10. The method of Embodiment 9, wherein the fuel cell is operated at a CO₂ utilization of 80% or more.
Embodiment 11. The method of Embodiment 9 or 10, wherein the cathode input stream comprises 5.0 vol % or less of CO₂, or wherein the cathode exhaust comprises 1.0 vol % or less of CO₂, or a combination thereof.
Embodiment 12. The method of any of Embodiments 9 to 11, wherein the cathode input stream comprises 4.0 vol % to 10 vol % of CO₂.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

What is claimed is:

1. A molten carbonate fuel cell, comprising:
an anode;
a first separator plate;
an anode collector in contact with the anode and the first separator plate to define an anode gas collection zone between the anode and the first separator plate;
a cathode having a cathode surface;
a second separator plate;
a cathode current collector in contact with the second separator plate and adjacent to the cathode surface to define a cathode gas collection zone between the cathode and the second separator plate, the cathode current collector having a contact area of less than 55%;
a structural mesh layer disposed between the cathode surface and the cathode current collector, the structural mesh layer comprising 50 openings/cm² or more and having a mesh contact area of 55% to 75%; and
an electrolyte matrix comprising an electrolyte between the anode and the cathode.

2. The molten carbonate fuel cell of claim 1, wherein the structural mesh layer comprises 75 openings/cm² or more.

3. The molten carbonate fuel cell of claim 1, wherein the structural mesh layer comprises 125 openings/cm² or more.

4. The molten carbonate fuel cell of claim 1, wherein the contact area of the cathode current collector is 50% or less.

5. The molten carbonate fuel cell of claim 1, wherein the structural mesh layer provides electrical contact between the cathode current collector and the cathode surface.

6. The molten carbonate fuel cell of claim 1, wherein an average contact area diffusion length is 1.0 mm or less.

7. The molten carbonate fuel cell of claim 1, wherein the average cathode gas lateral diffusion length is 0.35 mm or less.

8. The molten carbonate fuel cell of claim 1, wherein the structural mesh layer comprises a thickness of 0.25 mm to 0.80 mm.

9. The molten carbonate fuel cell of claim 1, wherein the structural mesh layer is composed of stainless steel.

10. A method for producing electricity in a molten carbonate fuel cell, the method comprising:
introducing an anode input stream comprising H₂, a reformable fuel, or a combination thereof into an anode gas collection zone, the anode gas collection zone being defined by an anode surface, a first separator plate, and an anode collector providing support between the anode surface and the separator plate;
introducing a cathode input stream comprising O₂ and CO₂ into a cathode gas collection zone, the cathode gas collection zone being defined by a cathode surface, a second separator plate, and a cathode current collector adjacent to the cathode surface and in contact with the second separator plate, a structural mesh layer being disposed between the cathode surface and the cathode current collector, the structural mesh layer comprising 50 openings/cm² or more and having a mesh contact area of 55% to 75%, the cathode current collector having a contact area of less than 55%; and
operating the molten carbonate fuel cell at an average current density of 60 mA/cm² or more to generate electricity, an anode exhaust, and a cathode exhaust.

11. The method of claim 10, wherein an average contact area diffusion length is 1.0 mm or less.

12. The method of claim 10, wherein the contact area of the cathode current collector is 50% or more.

13. The method of claim 10, wherein the average cathode gas lateral diffusion length is 0.35 mm or less.

14. The method of claim 10, wherein the structural mesh layer comprises 75 openings/cm² or more.

15. The method of claim 10, wherein the structural mesh layer comprises 125 openings/cm² or more.

16. The method of claim 10, wherein the fuel cell is operated at a CO₂ utilization of 80% or more.

17. The method of claim 10, wherein the cathode input stream comprises 5.0 vol % or less of CO₂, or wherein the cathode exhaust comprises 1.0 vol % or less of CO₂, or a combination thereof.

18. The method of claim 10, wherein the cathode input stream comprises 4.0 vol % to 10 vol % of CO₂.

19. The method of claim 10, wherein the structural mesh layer comprises a thickness of 0.25 mm to 0.80 mm.

20. The method of claim 1, wherein the structural mesh layer provides electrical contact between the cathode current collector and the cathode surface.
